(19) United States
(12) Patent Application Publication
(10) Pub. No.: US 2026/0285618 A1
(43) Pub. Date: Sep. 24, 2026

(54) DEVICES AND METHODS FOR OBJECT MANIPULATION

(71) Applicant: Walmart Apollo, LLC, Bentonville, AR (US)

(72) Inventors: Tomas A. Blodgett, Fayetteville, AR (US); Gerald J. Byers, Springfield, MO (US); Shane T. Shelbourn, Pea Ridge, AR (US); Swetha Mahadevan, Bentonville, AR (US)

(21) Appl. No.: 19/469,990

(22) PCT Filed: Mar. 28, 2024
(86) PCT No.: PCT/US2024/021886

§ 371 Date: Sep. 26, 2025

Related U.S. Application Data
(60) Provisional application No. 63/456,404, filed on Mar. 31, 2023.
(60) Provisional application No. 63/456,407, filed on Mar. 31, 2023.
(60) Provisional application No. 63/536,608, filed on Sep. 5, 2023.
(60) Provisional application No. 63/536,609, filed on Sep. 5, 2023.

(51) Int. Cl. B65G 47/91; B25J 15/00; B25J 15/06; B65G 41/00; B65G 61/00

(52) U.S. Cl. CPC B65G 47/91; B25J 15/0014; B25J 15/0616; B65G 41/005; B65G 61/00

(57) ABSTRACT

In some embodiments, devices and methods are provided herein useful to grip, manipulate, and move an object. In some embodiments, an object manipulation device may include a base configured to be attached to a robotic manipulator, a tool conveyor coupled to the base, and a gripping tool having at least one gripping surface and coupled to the base via a gripping tool actuator. The tool conveyor may include a conveyor surface configured to move an object on the conveyor surface from a first edge to a second edge of the tool conveyor.

### CROSS-REFERENCE TO RELATED APPLICATIONS

This application claims the benefit of Patent Application Nos. 63/456,404 filed Mar. 31, 2023, 63/456,407 filed Mar. 31, 2023, 63/536,608 filed Sep. 5, 2023, and 63/536,609 filed Sep. 5, 2023, which are incorporated herein by reference in their entirety.

### TECHNICAL FIELD

This invention relates generally to end of arm tools.

### BACKGROUND

An end-of-arm tool (EoAT) generally refers to a device or tool that is attached to the end of a robotic arm or manipulator. An EoAT can come into direct contact with the workpiece or performs the specific task for which the robot has been programmed. In some conventional approaches, object manipulation in a commercial product facility has been a completely manual process.

### BRIEF DESCRIPTION OF DRAWINGS

Disclosed herein are embodiments of systems, apparatuses and methods pertaining to devices and methods for object manipulation. This description includes drawings, wherein:

FIG. 1 depicts an object manipulation device in accordance with some embodiments.

FIG. 2 depicts an object manipulation device of FIG. 1 coupled to a robotic manipulator of a freight unloading/loading system in accordance with some embodiments.

FIG. 3A is a side view of the object manipulation device coupled to the robotic manipulator in accordance with some embodiments.

FIG. 3B is a top view of the object manipulation device coupled to the robotic manipulator in accordance with some embodiments.

FIG. 4 is a block diagram of a system to manipulate an object according to some embodiments.

FIG. 5 is a flowchart depicting an example method to manipulate an object in accordance with some embodiments.

FIGS. 6A-6G illustrate the object manipulation device in operation in accordance with some embodiments.

FIG. 7 is a flowchart depicting an example method to manipulate an object in accordance with some embodiments.

FIGS. 8A-8G depict the object manipulation device in operation in accordance with some embodiments.

FIG. 9 is a flowchart depicting an example method to manipulate an object in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to grip, manipulate, and move an object. In some embodiments, an object manipulation device comprises a base configured to be attached to a robotic manipulator, a tool conveyor coupled to the base, the tool conveyor having a conveyor surface configured to move an object on the conveyor surface from a first edge to a second edge of the tool conveyor, and a gripping tool having at least one gripping surface and coupled to the base via a gripping tool actuator, wherein the gripping tool actuator is configured to extend a gripping surface of the gripping tool to grip the object and retract the gripping surface to release the object onto the tool conveyor.

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

In logistics, loading and unloading cases (boxes, cases, etc.) from trailers or containers can be a time-consuming process. In some embodiments, a device is provided which enables automation of at least a portion of the unloading workflow and has high throughput and maintains robust case acquisition ability. Many existing end-of-arm tools (“EoATs”) to grip an object encounter challenges for case acquisition and handling in trailers or containers because the walls, ceiling, and floor of trailers or containers create constraints that limit the approaches and acquisition of a manipulator. Further, existing EoATs often require extensive motion of the robotic manipulator in a container or trailer, which is not desirable. Moreover, existing EoATs have limitations in handling non-typical cases and scenarios and thus, often require manual intervention. Devices according to some embodiments may be applied in narrow work environments such as an environment where the surface of the object is in close proximity to ceilings, floors, and/or walls. In some embodiments, the device can pick cases that are up against a side wall, ceiling, and/or floor. Sometimes, the top surface of a case, which is often the most accessible surface. However, in a trailer or container, it is often not possible to pick a case from the top. Embodiments of the disclosed device allow a case to be picked from any exposed surface, which may be the top or the side of the case.

In some embodiments, the device may reduce the amount and range of motion the manipulator would go through to acquire and release a case. In some embodiments, embodiments of the disclosed device enable manipulation of non-flat surfaces such as damaged or oddly shaped cases.

Another typically problematic scenario is when the product inside a case is heavy and/or the bottom seal of a case is weak. Embodiments of the disclosed device may eliminate or reduce the likelihood that the product in the cases falls out of the case via the bottom surface during the case manipulation, such as unloading and loading by providing continuous bottom support to the cases.

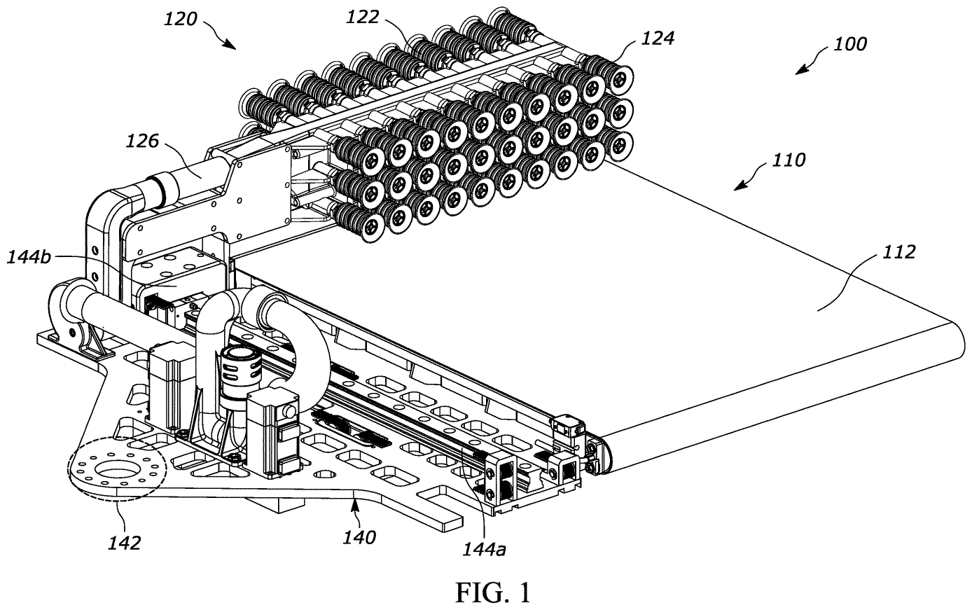

Various embodiments and examples of object manipulation devices are described herein. Exemplary FIGS. 1-8G are provided to illustrate various embodiments. And it is noted that when describing certain embodiments, certain features may be shown in one or more of FIGS. 1-8G.

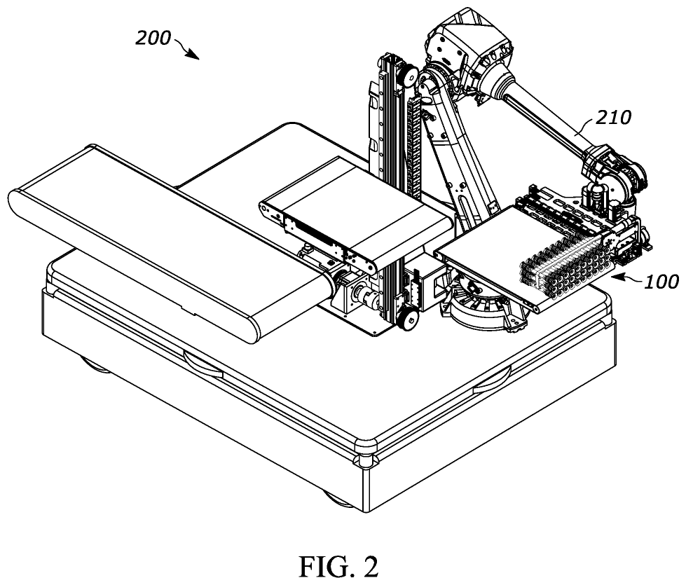

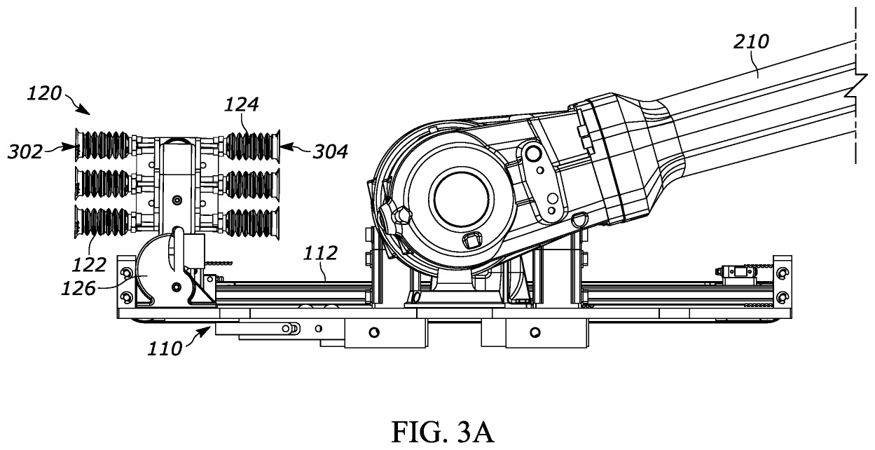

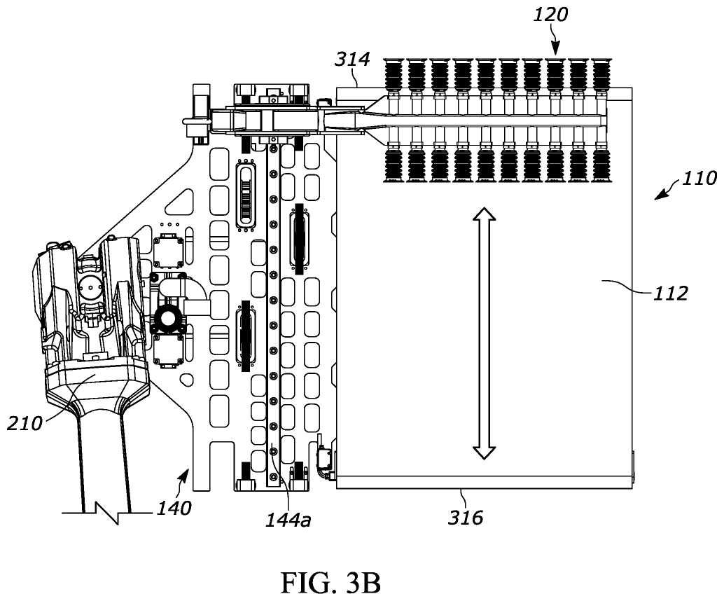

FIG. 1 depicts an object manipulation device 100 in accordance with some embodiments. The object manipulation device 100 may be an EoAT and may be coupled to the robotic manipulator such as a robotic arm. FIG. 2 depicts the object manipulation device 100 of FIG. 1 coupled to a robotic manipulator 210 of a freight unloading/loading system 200 in accordance with some embodiments. FIG. 3A is a side view of the object manipulation device 100 coupled to the robotic manipulator 210 in accordance with some embodiments. FIG. 3B is a top view of the object manipulation device 100 coupled to the robotic manipulator 210 in accordance with some embodiments.

Referring to FIG. 1, in some embodiments, the object manipulation device 100 includes a base 140, a tool conveyor 110, and a gripping tool 120. The tool conveyor 110 and the gripping tool 120 may be coupled to the base 140. The object manipulation device 100 may be attached to a robotic manipulator via the base. The base 140 may be configured to be attached to robotic manipulator 210. In some embodiments, the base 140 may comprise a coupling portion 142 that has one or more openings to facilitate coupling with the end of the robotic manipulator such that the position and orientation of the object manipulation device 100 can be controlled via the robotic manipulator. In some embodiments, the base 140 may further comprise powered mechanism for controlling the orientation (e.g., pitch, yaw, and/or roll) of tool conveyor 110 and/or the gripping tool 120 independent of the robotic manipulator 210.

In some embodiments, the robotic manipulator 210 may be a multi-axis robotic arm. In some embodiments, the robotic manipulator 210 may be a custom design with two or more axis. In some embodiments, the manipulator 210 may have four or six axis. In some embodiments, the robotic manipulator 210 includes multiple arms that are pivotally, rotatably, and/or statically attached.

The tool conveyor 110 has conveyor surface 112 configured to move an object on the conveyor surface. The tool conveyor 110 is configured to move the object thereon between edges 314 and 316 on opposite sides of the tool conveyor 110. As used herein, depending on the conveyor direction of the tool conveyor, edge 314 may be referred to as the first edge and edge 316 may be referred to as the second edge, or edge 316 may be referred to as the first edge and edge 314 may be referred to as the second edge. Generally, the first edge may refer to the starting point of the conveyor direction of the tool conveyor, and the second edge may refer to an endpoint of the conveyor direction of the tool conveyor. In some embodiments, the tool conveyor 110 may be, but not limited to, a motorized conveyor. In some embodiments, the edges 314 and 316 may also be referred to as distal or proximal edges depending on the orientation of the object manipulation device 100 relative to the system 200.

In some embodiments, the gripping tool 120 may include at least one gripping surface such as gripping surface 302 or 304. In some embodiments, the gripping tool 120 may include two gripping surfaces 302 and 304 opposite each other. The gripping surface 302, 304 may generally refer to a surface formed by portions of the gripping tool 120 that is configured to contact the surface of an object when the gripping tool 120 grips the object. In some embodiments, the gripping tool 120 may include a suction cup, suction cup array 122, 124, and/or a suction pad (not shown) to grip an object. In some embodiments, the suction pad may be an open-cell foam suction pad. In some embodiments, the gripping tool 120 may comprise a plurality of suction cup arrays 122, 124. In some embodiments, two of the plurality of suction cup arrays 122, 124 may be opposite to each other. In some embodiments, the gripping tool 120 may include other types of gripping mechanisms that can grip the case from a side surface such as a plurality of figures configured to grasp or pinch an object, or a plurality of pins configured to penetrate surface of an object to grip the object. In some embodiments, the gripping tool 120 may comprise the suction cup, the suction pad, the plurality of fingers, the plurality of pins, or a combination thereof. The plurality of fingers may release the grasped/pinched object by opening the fingers. The plurality of pins may release the gripped object by retracting the pins from the surface of the gripped object. Generally, any exposed surface of an object to be gripped may be referred to as a side surface.

In some embodiments, the device 100 may include a gripping tool actuator 126. The gripping tool 120 may be coupled to the base 140 via the gripping tool actuator 126. The gripping tool actuator 126 may move or actuate the gripping tool 120 and gripping surfaces 302, 304.

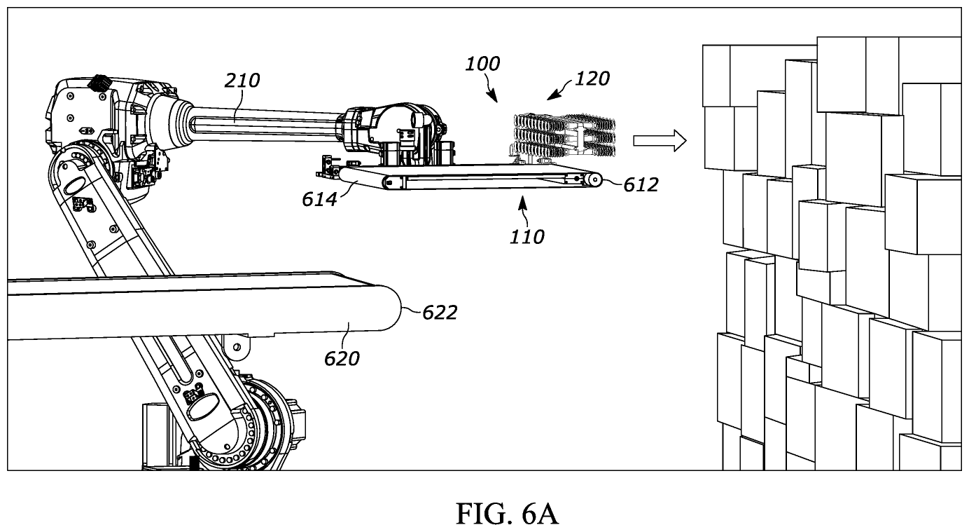

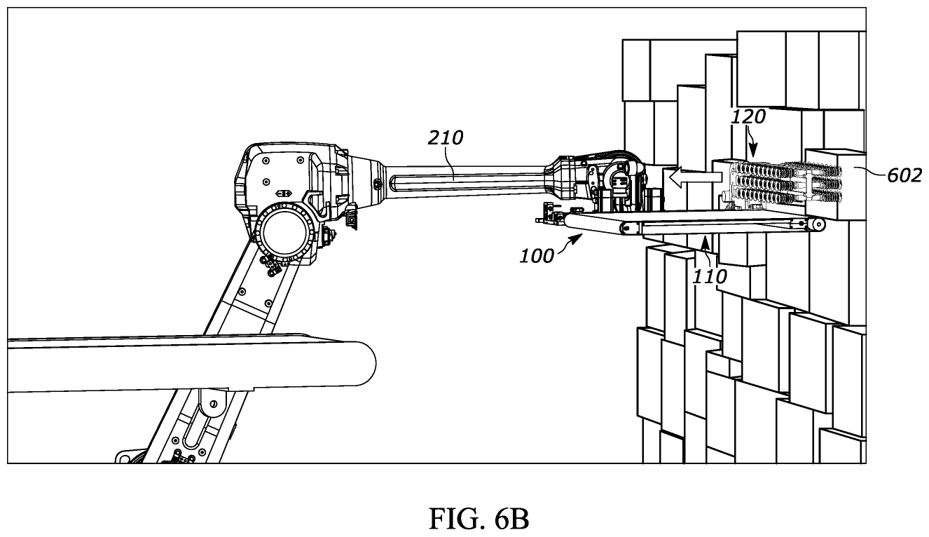

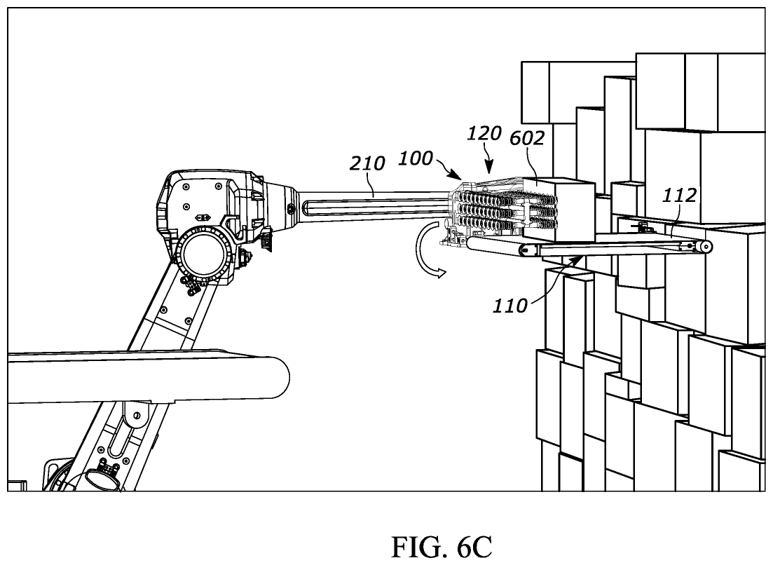

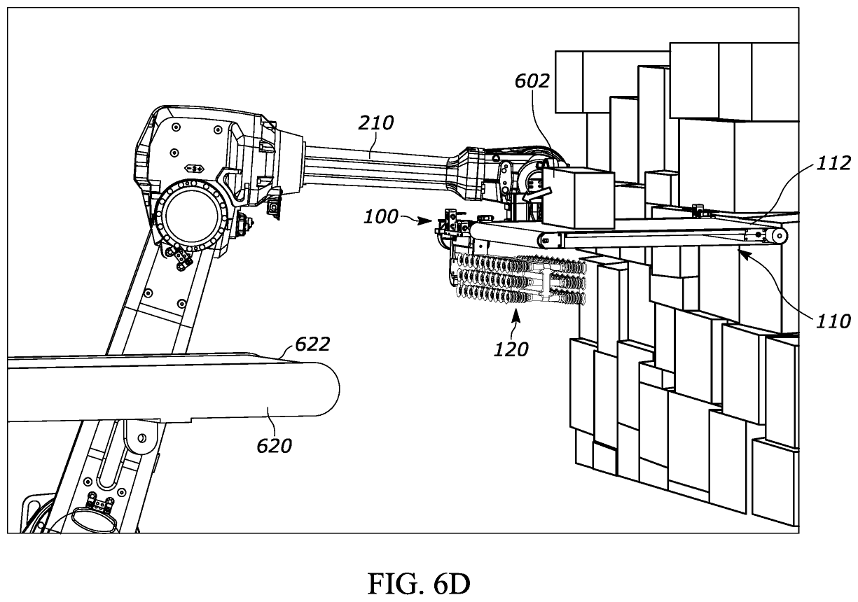

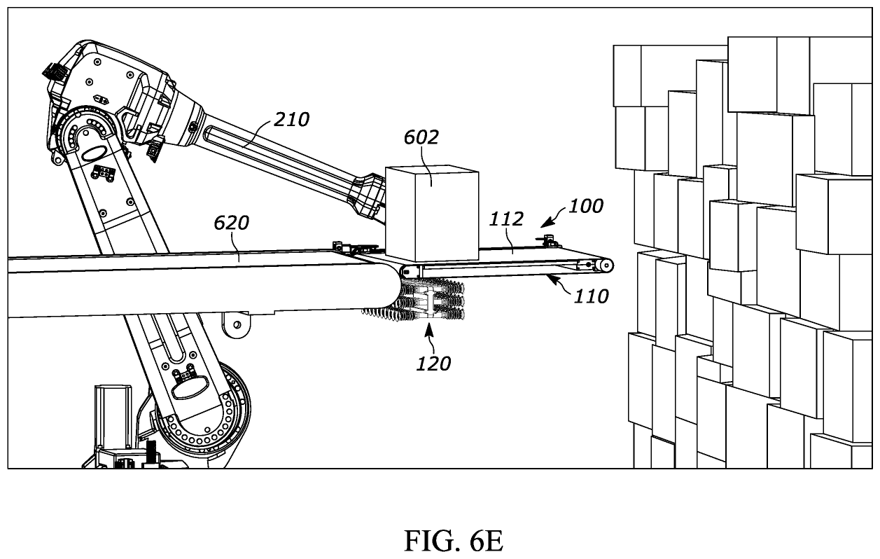

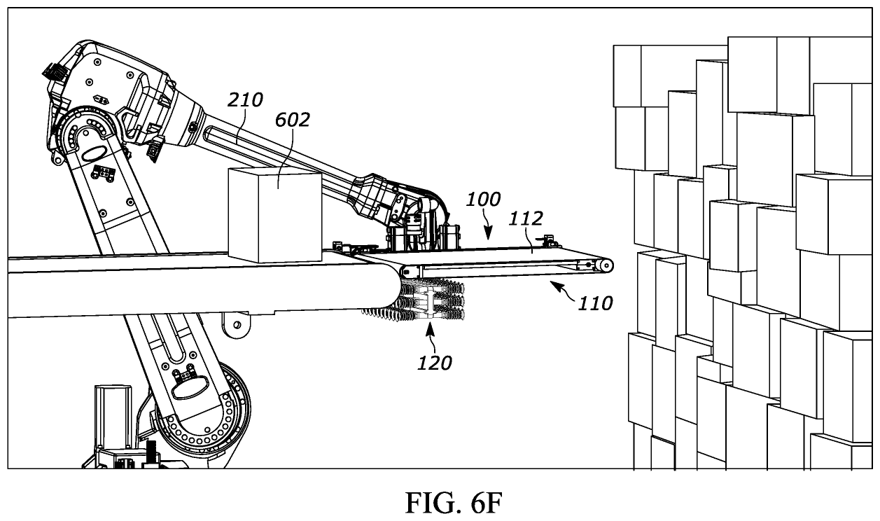

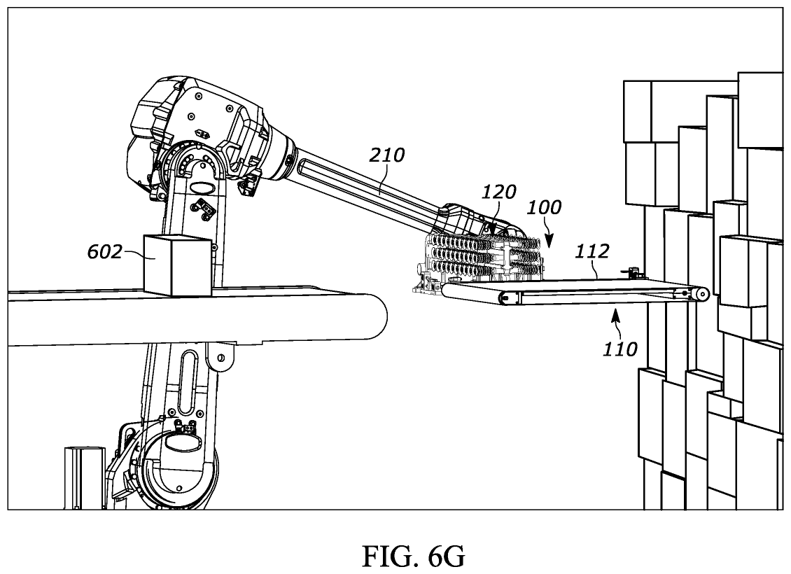

In some embodiments, the gripping tool actuator 126 may move the gripping tool 120 along the upper side of the tool conveyor 110. For example, by moving the gripping tool 120 on the upper side of the tool conveyor 110, the gripping tool actuator 126 may extend the gripping surface 302, 304 of the gripping tool 120 to grip an object and retract the gripping surface 302, 304 of the gripping tool to release the object on the conveyor surface of the tool conveyor 110. Extending a gripping surface 302, 304 may generally refer to moving the gripping surface toward the object to be gripped. When extending the gripping surface 302, 304, the gripping surface may move from the middle of the tool conveyor toward a distal edge 612 (See FIG. 6A), an edge facing the object to be gripped. Retracting a gripping surface 302, 304 may generally refer to moving the gripping surface in a direction from the distal edge 612 toward the proximal edge 614 (See FIG. 6A), which is the opposite edge of the distal edge 612. In some embodiments, at least one of the gripping surfaces 302, 304 may be extended beyond the distal edge 612 of the tool conveyor to grip an object. In some embodiments, at least one of the gripping surfaces 302, 304 may be fully retracted to the proximal edge of the tool conveyor. In some other embodiments, the gripping surface 302, 304 may be partially retracted so that the gripping surface 302, 304 may be positioned somewhere between the distal edge 612 and the proximal edge 614.

In some embodiments, the base 140 may comprise a guide assembly to facilitate the extraction and retraction of the gripping surface 302, 304. The gripping tool actuator 126 may extend and retract the gripping surface 302, 304 along a path the guide assembly provides. In some embodiments, the guide assembly comprises an elongated guide 144a and a sliding unit 144b configured to engage with the elongated guide 144a and move along the elongated guide 144a. In some embodiments, the gripping tool actuator 126 may be attached to the sliding unit 144b. The guide assembly may have various structures such as a rail assembly or a bearing assembly. The bearing assembly may be but not limited to a rolling bearing such as a ball bearing and roller bearing, or a sleeve bearing.

In some embodiments, when gripping tool actuator 126 retracts the gripping surface 302, 304, the gripping surface may be moved at a speed corresponding to the conveyor speed of the tool conveyor 110 and in a direction corresponding to a conveyor direction of the tool conveyor 110 while the gripping tool 120 is gripping an object and at least a portion of the gripped object is on the tool conveyor 110. By matching the direction and speed of the gripping surface 302, 304 to the conveyor speed and conveyor direction of the tool conveyor 110, the gripping tool 120 and the tool conveyor 110 may cooperatively move the object.

In some embodiments, the tool conveyor 110 is configured to move an object on the conveyor surface from a first edge to a second edge of the tool conveyor. The tool conveyor 110 may move the object on the conveyor surface 112 while the robotic manipulator 210 moves the object manipulation device 100 from the object-gripping location to the object-release location. In some embodiments, the conveyor speed of the tool conveyor 110 is controllable based on a distance relative to an object-gripping location and an object-release location. The conveyor speed of the tool conveyor 110 may be controlled in order for the object on the conveyor surface 112 to reach the proximal edge of the tool conveyor 110 when or shortly before the object manipulation device 100 reaches the object-release location. For example, if the distance between the object-gripping location and the object-release location is relatively long, the conveyor speed of the tool conveyor 110 may be relatively slow. By contrast, if the distance between the object gripping location to the object release location is relatively short, the conveyor speed of the tool conveyor 110 may be relatively fast. The conveyor speed of the tool conveyor 110 moving the object from the first edge to the second edge may refer to the average conveyor speed. In some embodiments, after receiving the object, the tool conveyor 110 may stop when the object is fully resting on the tool conveyor and/or is at the center of the tool conveyor. In some embodiments, gripping tool 120 may continue to hold the object on the tool conveyor 110 to prevent the object from being dropped. In some embodiments, the tool conveyor 110 and/or the gripping tool 120 may resume movement when the object manipulation device 100 is at or near the object release location to transfer the object off of the tool conveyor 110.

In some embodiments, the gripping tool 120 may move from the upper side of the tool conveyor 110 to a lower side of the tool conveyor 110 and may also move from the lower side of the tool conveyor to the upper side of the tool conveyor actuated by the gripping tool actuator 126. In some embodiments, the gripping tool 120 may change its position from the upper side to the lower side and from the lower side to the upper side of the tool conveyor by rotating or pivoting about an edge of the tool conveyor 110. In some embodiments, the gripping tool actuator 126 may be configured to fully rotate around the tool conveyor 110 in both clockwise and counter-clockwise directions. In some embodiments, the gripping tool actuator 126 may increase the speed of moving/retracting the gripping tool 120 (and gripping surface) at some point while the robotic manipulator 210 moves the object manipulation device 100 toward the object-release location, such that the gripping surface of the gripping tool 120 may move faster than the conveyor speed of the tool conveyor 110. By speeding up the moving/retracting speed of the gripping tool 120, the gripping surface of the gripping tool 120 may be retracted from the object on the tool conveyor 110 and then rotate out of the way in order to clear the path for the object on the tool conveyor 110. This speed control may prevent the robotic manipulator 210 from pausing its movement for clearing the moving path of the object on tool conveyor 110 and, thus, increase the efficiency of object manipulation in loading/unloading scenarios. In some embodiments, before the gripping tool actuator 126 increases the speed of moving/retracting the gripping tool 120, the gripping tool 120 may remove any gripping force applied to the object on the tool conveyor 110.

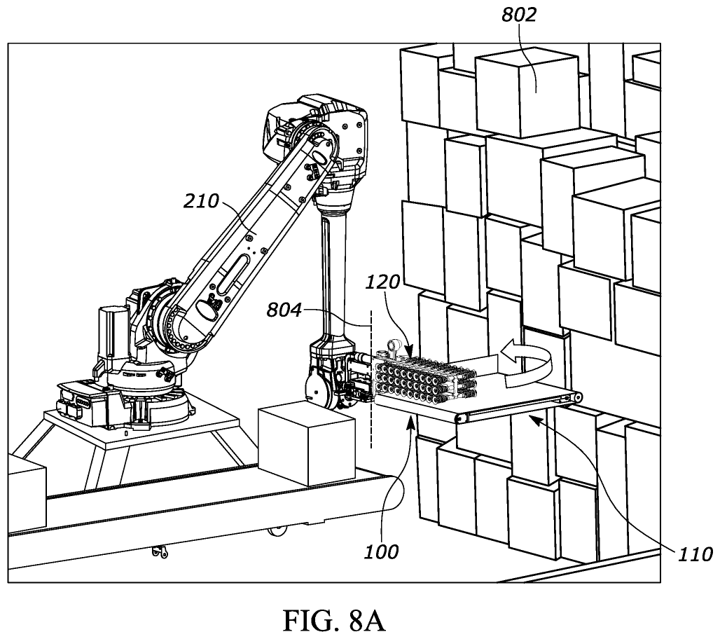

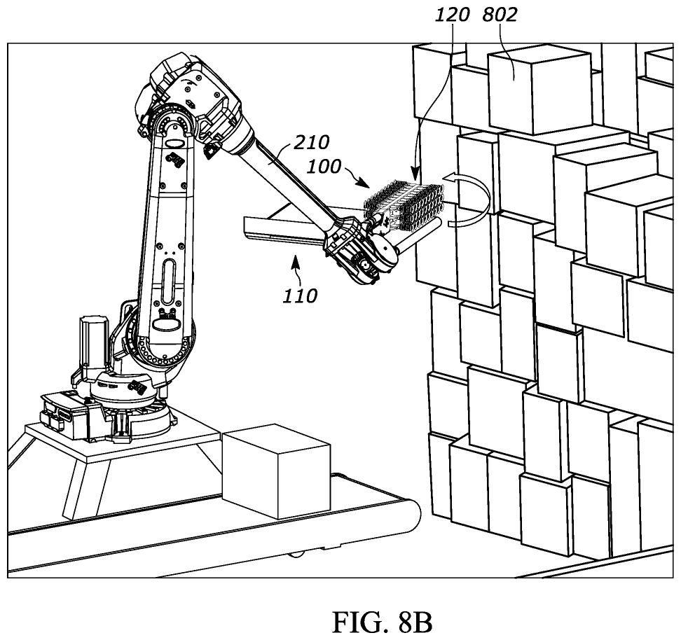

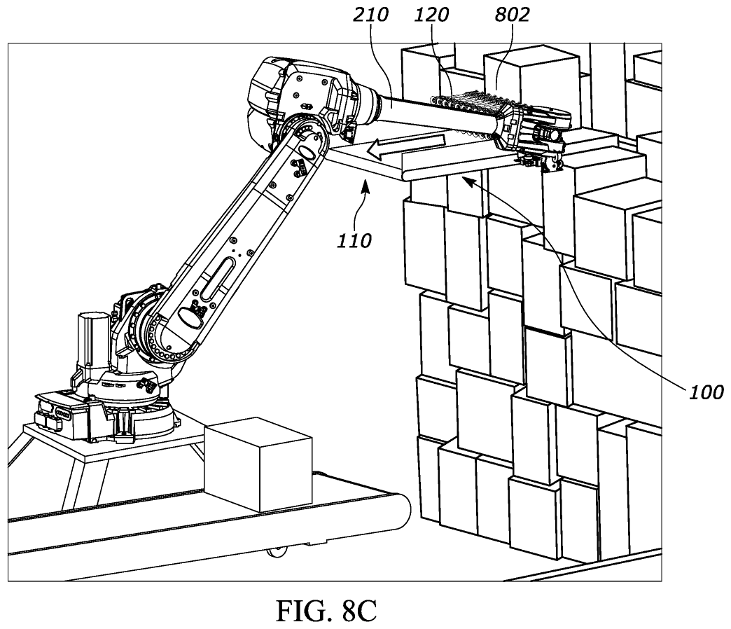

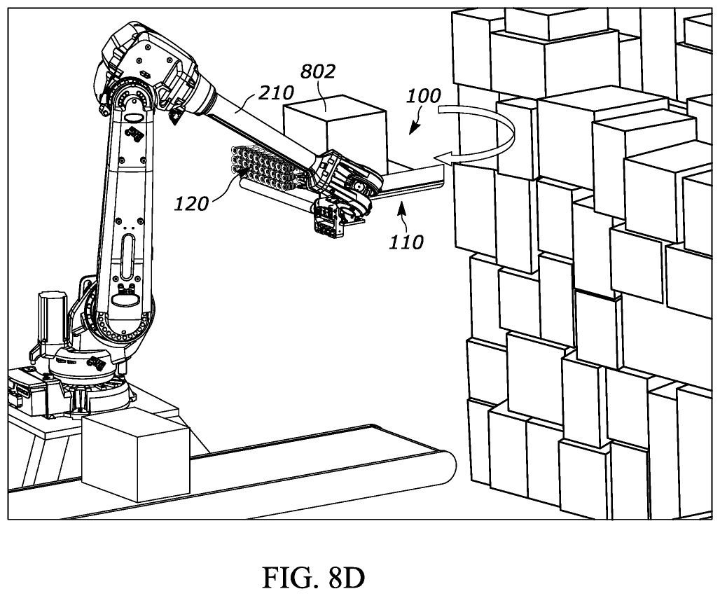

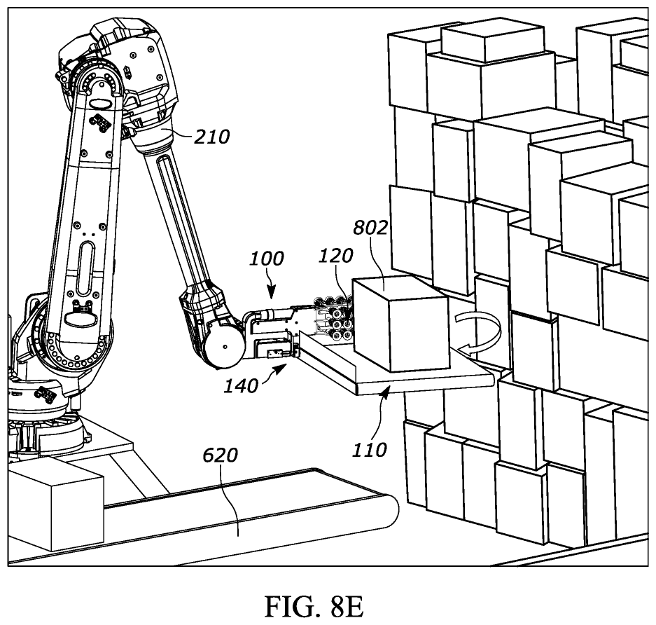

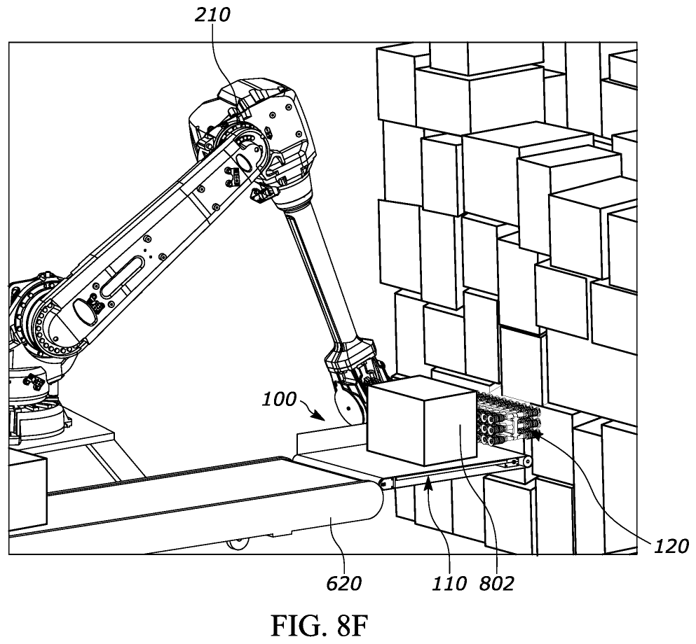

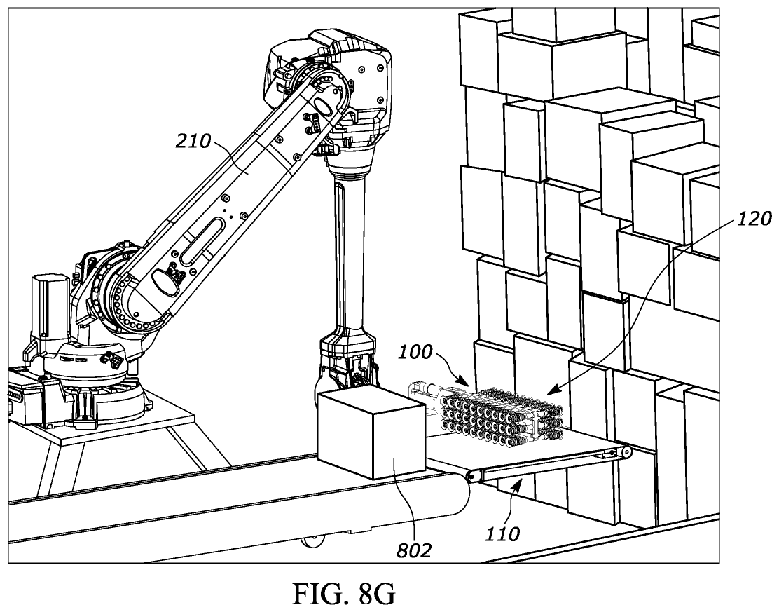

In some embodiments, the object manipulation device 100 may be rotated about axis 804 (see FIG. 8A) substantially perpendicular to the conveyor surface 112 of the tool conveyor by the robotic manipulator 210. Rotating the object manipulation device 100 switches the distal edge of the tool conveyor and the proximal edge with each other. In some embodiments, the tool conveyor may be rotated by about 180 degrees. The degree of rotation of the tool conveyor 110 may be adjusted based on the arrangement of an object to be gripped. For example, the robotic manipulator 210 may rotate the object manipulation device 100 to its left side to grip objects stacked near or against the left wall of a container/trailer.

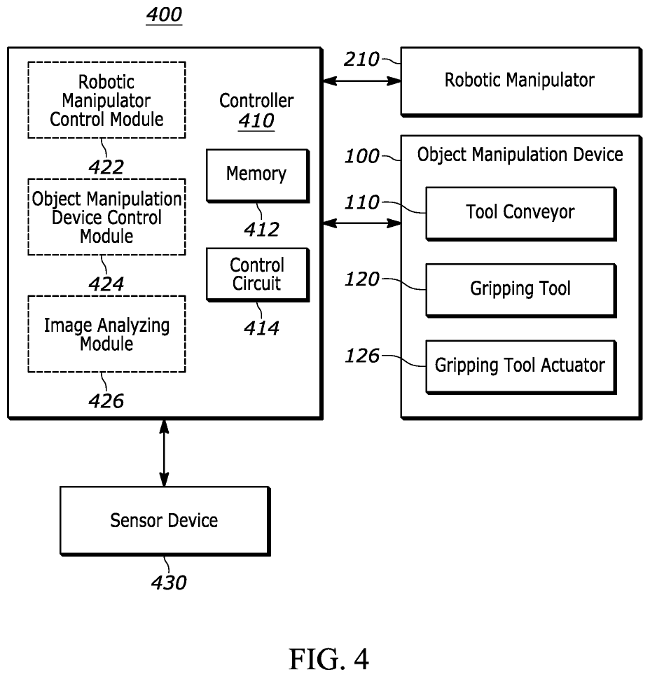

FIG. 4 is a block diagram of a system 400 to manipulate an object according to some embodiments. The system 400 may comprise a controller 410, the object manipulation device 100, and the robotic manipulator 210. The object manipulation device 100 may be coupled to the robotic manipulator 210.

In some embodiments, the system 400 may further comprise one or more sensor devices 430. The sensor devices 430 may be a camera, an imaging sensor, a depth sensor, an infrared sensor, 3D sensors, or other imaging devices. The sensor device 430 may use various image recognition and image processing techniques. The sensor device may scan or capture images in front of the system 400 in real-time or near real-time.

In some embodiments, the controller 410 may be operably connected to the robotic manipulator 210 and the object manipulation device 100 and may control the robotic manipulator 210 and the object manipulation device 100 illustrated in FIGS. 1-3B. However, it is understood that the controller 410 may control object manipulation systems differently configured. The controller 410 may comprise a memory 412 and a control circuit 414.

The memory 412 may store data and codes for various control/analysis modules to operate the system 400. The memory 412 may comprise but is not limited to non-volatile memory such as read-only memory (ROM) and/or volatile memory such as an erasable programmable read-only memory (EPROM). The control circuit 414 may access the memory 412 and execute the codes for the control/analysis modules stored in the memory 412, for example, by using the corresponding programming as will be well understood by those skilled in the art.

In some embodiments, the control circuit 414 may operably couple to the memory 412. In some embodiments, the memory 412 may be integral to the control circuit 414 or may be physically discrete in whole or in part from the control circuit 414 as desired. This memory 412 may also be local with respect to the control circuit 414 (where, for example, both share a common circuit board, chassis, power supply, and/or housing) or may be partially or wholly remote with respect to the control circuit 414 (where, for example, the memory is physically located in another housing).

In some embodiments, the controller 410 may comprise a robotic manipulator control module 422 and an object manipulation device control module 424. In some embodiments, the controller 410 may further comprise an image analyzing module 426. Codes for each module may be stored in the memory 412 and executed by the control circuit 414. Each module of the controller may control the devices and components by sending electrical signals to each device and component. In some embodiments, the robotic manipulator control module 422 and the object manipulation device control module 424 may be integrated as a single module.

The robotic manipulator control module 422 may be configured to control the robotic manipulator 210. When the robotic manipulator 210 is the multi-axis robotic arm, the robotic manipulator control module 422 may control the position and movement of each axis and joint of the robotic manipulator. For example, the robotic manipulator control module 422 may control the operation of the robotic manipulator 210 to extend the object manipulation device 100 attached to its end toward an object to be gripped and retract the object manipulation device 100 to move the gripped object to the object release location.

The object manipulation device control module 424 may be configured to control the operation of the object manipulation device 100. The object manipulation device control module 424 may control the operation of tool conveyor 110. For example, the object manipulation device control module 424 may stop and resume the operation of the conveyor of the tool conveyor 110 and adjust the conveyor speed and direction of the tool conveyor 110. The object manipulation device control module 424 may be further configured to control the movement and operation of the gripping tool 120 and the gripping tool actuator 126. For example, the object manipulation device control module 424 may control the gripping tool actuator 126 to extend and retract the gripping surface of the gripping tool 120. The object manipulation device control module 424 may control the gripping mechanism to grip and release an object. For example, when the gripping mechanism includes a suction cup array 122, 124, or a suction pad, the object manipulation device control module 424 may send signals to the suction cup array 122, 124, or the suction pad to apply and release the vacuum suction force. In another example, when the gripping mechanism includes a plurality of figures, the object manipulation device control module 424 may send signals to an actuator for the plurality of fingers to move the figures in order to grasp the object. Similarly, when the gripping mechanism includes a plurality of pins, the object manipulation device control module 424 may send signals to an actuator for the plurality of pins to penetrate the surface of the object in order to grip the object.

In some embodiments, the image analyzing module 426 may be configured to process and analyze the images scanned and captured by the sensor devices 430. The image analyzing module 426 may recognize the location, position, size, shape, lines, edges, corners, surfaces, and the near/far distance of the objects in front of the system 400. In some embodiments, the image analyzing module 426 may create a 3D image of objects in front of the system 400. For example, the edges and distances of each case in the wall of cases may be measured and calculated relative to the object manipulation device 100. The image processing module may operate alone or in concert with other modules to identify and select specific objects to be gripped.

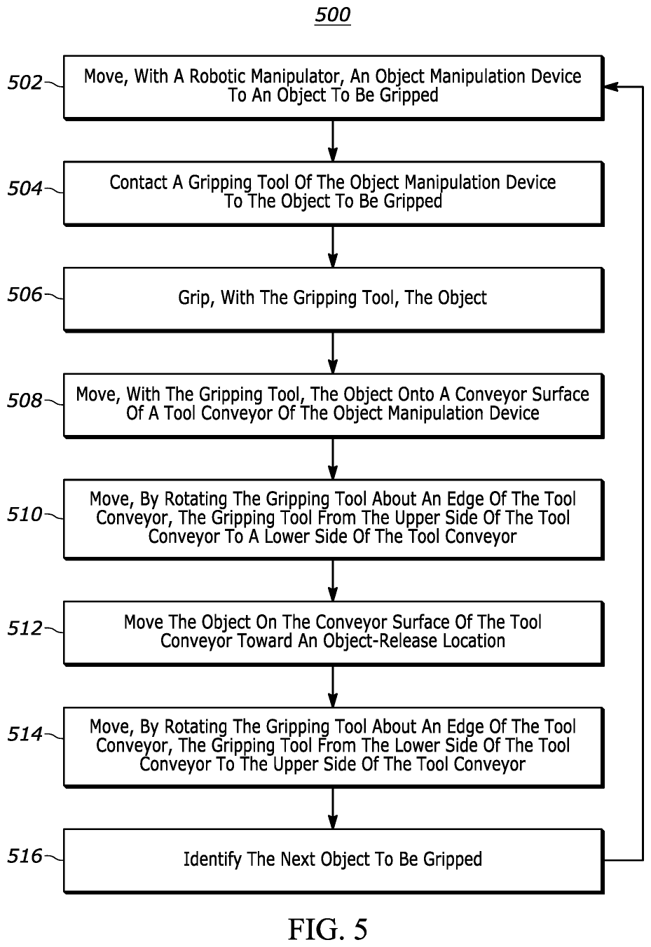

FIG. 5 is a flowchart depicting an example method 500 to manipulate an object, such as a case, in a commercial product facility that may be performed using the system 400 in accordance with the embodiments described above. This control circuit 414 is configured (for example, by using corresponding programming as will be well understood by those skilled in the art) to carry out or send signals to carry out one or more of the steps, actions, and/or functions described herein.

FIGS. 6A-6G depict the system 400 in operation to manipulate a case 602 according to the exemplary method 500. FIG. 6A illustrates the object manipulation device 100 approaching a case 602 to be gripped. FIG. 6B illustrates the object manipulation device 100 gripping the case 602. FIG. 6C illustrates the object manipulation device 100 moving, with gripping tool 120 and tool conveyor 110, the case 602 along the upper side of tool conveyor 110. FIG. 6D illustrates the object manipulation device 100 with the gripping tool 120 which has been moved from the upper side of the tool conveyor 110 to the lower side of the tool conveyor 110. FIG. 6E illustrates the object manipulation device 100 which has been moved to and aligned with a receiving conveyor 620. FIG. 6F illustrates that the case 602 has been transferred from the object manipulation device 100 to the receiving conveyor 620. FIG. 6G illustrates the object manipulation device 100 with the gripping tool 120 which has been moved from the lower side of the tool conveyor 110 to the upper side of the tool conveyor 110.

In some embodiments, the steps herein may be performed to unload cases from a container/trailer from a stack of cases. The flow begins at step 502.

In step 502, the robotic manipulator 210 moves the object manipulation device 100 to the case 602 to be gripped such that the object manipulation device 100 approaches the case 602. As shown in FIGS. 6A-6B, when object manipulation device 100 reaches the object-gripping location, the distal edge 612 (an edge toward the case) of the tool conveyor 110 may be in alignment with (e.g., parallel to and/or at approximately the same heigh as) the bottom edge of the case 602. When a case to be gripped is tilted relative to the floor, the tool conveyor 110 may be tilted to align with the bottom edge of the case. When the tool conveyor 110 is in alignment with the bottom edge of the case 602, the distal edge 612 of the tool conveyor 110 may contact or be adjacent to the bottom edge of the case 602. The control circuit 414 may use the positional and image information acquired from the sensor devices 430 and the image analyzing module 426 when moving, with the robotic manipulator 210, the object manipulation device 100 and aligning the tool conveyor 110 with the case 602 to be gripped. The control circuit 414 may calculate and control the extension movements of the robotic manipulator 210 based on the positional and image information.

In step 504, the gripping tool actuator 126 may extend the gripping surface of the gripping tool 120 toward the case 602 to have the gripping surface of the gripping tool 120 contact one of the surfaces (e.g., side surface) of the case 602 as shown in FIG. 6B. In some embodiments, the gripping tool actuator 126 may extend the gripping surface beyond the distal edge of the tool conveyor 110 to grip the case 602. The gripping tool actuator 126 and the gripping tool 120 may be controlled based on the positional and image information acquired via the sensor devices 430 and image analyzing module 426.

In some embodiments, steps 502 and 504 may be conducted simultaneously. For example, while the robotic manipulator 210 is extending the object manipulation device 100 toward the case, the gripping tool actuator 126 may be extending the gripping surface toward the case. This simultaneous operation may reduce the cycle time of the manipulation of objects.

In step 506, the gripping tool 120 grips the case 602. In some embodiments, the gripping tool 120 may grip the case by applying a vacuum suction force to the surface of the case via the gripping surface. In some embodiments, the vacuum suction force may be applied with a suction cup array, a suction pad, or a combination thereof. In some embodiments, the gripping tool 120 may grip the case with other types of forces/mechanism. For example, the gripping tool 120 may grip the case 602 using the plurality of fingers or the plurality of pins. In some embodiments, gripping the case 602 in step 506 may comprise applying a vacuum suction force on the surface of the case 602, grasping, with the plurality of fingers, the case 602, and/or penetrating, with the plurality of pins, the surface of the case 602.

In step 508, the gripping tool 120 moves the case gripped onto a conveyor surface of a tool conveyor of the object manipulation device as shown in FIG. 6C. In some embodiments, the gripping tool 120 may draw and put the gripped case 602 onto the conveyor surface 112 of the tool conveyor 110 by retracting, with the gripping tool actuator 126, the gripping surface of the gripping tool 120. While the gripping tool 120 retracts the gripping surface to move the gripped case 602, at least a part or entire weight of the case 602 may be supported by the tool conveyor 110.

In some embodiments, once the gripping tool 120 puts at least a portion of the case 602 on the tool conveyor, the case may be moved toward the proximal edge 614 of the tool conveyor 110 by both the gripping tool 120 and the tool conveyor 110 until the gripping tool 120 releases the case 602. To facilitate movement of the case 602 on the tool conveyor 110, the gripping tool actuator 126 may retract the gripping surface of the gripping tool 120 in the same direction as the conveyor direction of the tool conveyor 110 and at the same speed as the conveyor speed of the tool conveyor 110 before the gripping tool 120 releases the case 602. After enough portion or entire portion of the case 602 is put on the tool conveyor 110, the gripping tool 120 may release the case.

By adding the tool conveyor 110 to the object manipulation device 100 configured to be coupled to the robotic manipulator 210, the system 400 may facilitate the manipulation of heavy objects and may eliminate or reduce the likelihood that the item in the case falls out of a case while the system moving the object from the gripping location to the release location with the object manipulation device 100.

In step 510, after releasing the case 602, the gripping tool 120 may be detached from the case and moved from the upper side of the tool conveyor 110 to the lower side of the tool conveyor 110 as shown in FIGS. 6C-6D. In some embodiments, the moving speed of the gripping tool 120 may be faster than the conveyor speed of the tool conveyor 110 in order for the gripping tool to be detached from the case 602. To move the gripping tool 120 from the upper side of the tool conveyor to the lower side of the tool conveyor 110, the gripping tool actuator 126 may rotate or drop the gripping tool toward the lower side of the tool conveyor 110. For example, the gripping tool actuator 126 may rotate the gripping tool 120 about the proximal edge 614 of the tool conveyor 110. Changing the position of the gripping tool 120 from the upper side to the lower side of the tool conveyor 110 may clear the path for the case on the tool conveyor to move toward the proximal edge without additional movement of the robotic manipulator 210 to clear the path, which may reduce the cycle time to move the cases in loading/unloading scenarios.

In step 512, the case 602 on the conveyor surface 112 of the tool conveyor 110 may be moved toward an object-release location as shown in FIGS. 6D-6E. The object-release location may refer to a location to which the robotic manipulator 210 and the object manipulation device 100 deliver an object. Moving the case 602 on the conveyor surface of the tool conveyor toward the object-release location may comprise moving, with the tool conveyor 110, the case 602 on the conveyor surface of the tool conveyor toward the proximal edge 614 of the tool conveyor 110 and moving, with the robotic manipulator 210, the object manipulation device 100 toward the object-release location. Moving the object on the conveyor surface of the tool conveyor toward the proximal edge of the tool conveyor and moving the object manipulation device toward the object-release location may be carried out concurrently. In some embodiments, the control circuit 414 may adjust the conveyor speed of the tool conveyor 110 based on the distance between the object-gripping location and the object-release location and based on the path along which the robotic manipulator 210 moves the object manipulation device 100 from the object-gripping location to the object-release location. In some embodiments, the control circuit 414 controls the movement of the robotic manipulator and the tool conveyor speed so that the case 602 on the tool conveyor reaches the proximal edge 614 of the tool conveyor 110 at the same time or shortly after the object manipulation device 100 reaches the object-release location. By controlling the timing of arrival of the case 602 at the proximal edge 614 of the tool conveyor 110 and the arrival of the object manipulation device 100 at the object-release location, the object may be delivered to the next position seamlessly and the cycle time to manipulate an object may be reduced.

In some embodiments, while the gripping tool 120 is receding from the case on the tool conveyor and rotating as described in step 510, the tool conveyor 110 may move the case 602 on its surface toward its proximal edge 614 and the robotic manipulator 210 may also move the object manipulation device 100 toward the object-release location.

In some embodiments, the system 400 may further include a receiving conveyor 620 configured to receive the object from the object manipulation device 100. When the system includes the receiving conveyor 620, the object-release location may correspond to the receiving point of the receiving conveyor 620. The receiving point of the receiving conveyor 620 may be a proximal edge 622 of the receiving conveyor 620. When the system comprises the receiving conveyor 620, with the gripping tool 120 out of the way, the robotic manipulator 210 may then align the tool conveyor 110 with the receiving conveyor 620. The proximal edge 614 of the tool conveyor 110 may be aligned with the proximal edge 622 of the receiving conveyor 620.

After the alignment, the case 602 may be moved from the tool conveyor 110 to the receiving conveyor 620 as shown in FIG. 6F. In some embodiments, both the tool conveyor 110 and the receiving conveyor 620 may operate to move the case 602 from the tool conveyor 110 to the receiving conveyor 620. In some embodiments, the conveyor speed of the tool conveyor 110 may match the conveyor speed of the receiving conveyor 620.

In step 514, once the case 602 has been fully transferred to the receiving conveyor 620, the gripping tool actuator 126 may rotate (or raise) back the gripping tool 120 from the lower side to the upper side of the tool conveyor 110 as shown in FIG. 6G and then extend the gripping surface toward an object for the next pick. While the gripping surface is moved toward the object, the robotic manipulator 210 may move the object manipulation device 100 toward the stack of cases for next picking.

In step 516, the system 400 may identify, with the sensor devices 430, a next case to be gripped. Although step 516 is illustrated after step 514, in some embodiments, the system may identify the next case to be gripped while one or more steps of steps 502 to 514 are being conducted. In some embodiments, the system 400 may identify the next case to be gripped prior to the completion of the case release from the object manipulation device 100 (i.e., tool conveyor 110). Image acquisition and processing time for the object identification may be potentially burdensome in terms of overall cycle time, but by identifying the next case to be gripped before the completion of the case release from the object manipulation device 100, the system 400 may avoid increases of the cycle time caused by image acquisition and process time.

The steps illustrated in FIG. 5 and FIGS. 6A-6G may be repeated to manipulate a plurality of cases. For example, the flow may continue after step 516, going back to step 502. Steps 502 to 516 may be repeated as many times as necessary. For example, steps 502 to 516 may be repeated until there remain no cases the system 400 should manipulate according to the method 500, or until the system 400 identifies no case to be gripped.

According to the illustrated embodiments, the system may manipulate objects with minimized or reduced movement of the robotic manipulator 210 and the object manipulation device 100. For example, the system 400 according to some embodiments may reduce or minimize the change of the orientation/location of the object manipulation device 100 to grip a case and release the gripped case at the object-release location. This allows the system to operate at a much higher rate, reduce robotic manipulator motion, and significantly reduce the possibility of dropping an object while it is being handled.

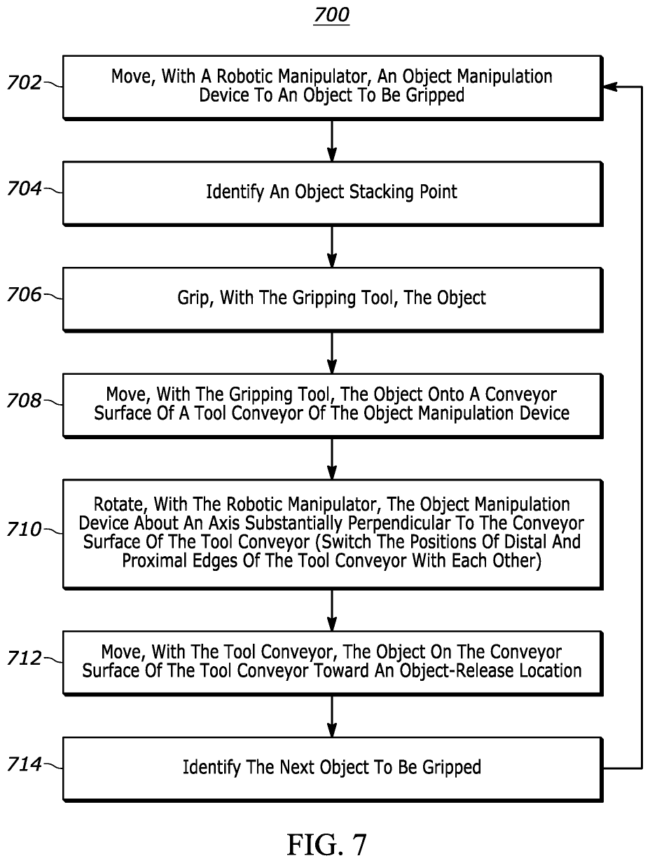

FIG. 7 is a flowchart depicting another example method 700 to manipulate a case in a commercial product facility that may be performed using the system 400 in accordance with the embodiments described above. This control circuit 414 is configured (for example, by using corresponding programming as will be well understood by those skilled in the art) to carry out one or more of the steps, actions, and/or functions described herein.

FIGS. 8A-8G depict the system 400 in operation according to the exemplary method 700. FIGS. 8A-8B illustrate the robotic manipulator 210 moving the object manipulation device 100 toward a case 802 to be gripped while rotating the object manipulation device 100. FIG. 8C illustrates the object manipulation device 100 gripping the case 802. FIG. 8D illustrates the object manipulation device 100 moving, with gripping tool 120 and tool conveyor 110, the case 802 along the upper side of tool conveyor 110. FIG. 8E illustrates the robotic manipulator 210 moving the object manipulation device 100 toward the receiving conveyor 620 while rotating the object manipulation device 100. FIG. 8F illustrates the object manipulation device 100 which has been moved to and aligned with a receiving conveyor 620. FIG. 8G illustrates that the case 802 has been transferred from the object manipulation device 100 to the receiving conveyor 620. The flow begins at step 702.

In step 702, the robotic manipulator 210 moves the object manipulation device 100 toward a case to be gripped. In some embodiments, as shown in FIG. 8A-8C, when object manipulation device 100 approaches the case 802, the robotic manipulator 210 may rotate the tool conveyor 110 about an axis 804 substantially perpendicular to the conveyor surface of the tool conveyor 110. By rotating the tool conveyor 110 about an axis 804 substantially perpendicular to the conveyor surface of the tool conveyor, the proximal edge and the distal edge of the tool conveyor may be switched with each other. If the gripping tool 120 is near the proximal edge of the tool conveyor 110 before the rotation, the gripping tool 120 may become near the distal edge of the tool conveyor 110 after the rotation. Therefore, rotating the tool conveyor 110 may reduce the movement of the gripping tool 120, such as extraction of the gripping tool 120 to contact the case to be gripped. Further, as shown in FIGS. 8A-8C, rotating the tool conveyor 110 may change the orientation of the robotic manipulator 210 relative to the object manipulation device 100, which may allow the object manipulation device 100 to access the walls of the trail without obstruction by the robotic manipulator 210.

For example, if the robotic manipulator 210 is to the left of the object manipulation device 100 before rotating the tool conveyor 110, the robotic manipulator may obstruct the access of the object manipulation device 100 to the left wall of the trailer. However, the robotic manipulator 210 may be to the right of the object manipulation device 100 after rotating the tool conveyor 110 about an axis 804 substantially perpendicular to the conveyor surface of the tool conveyor by about 180 degrees, and the object manipulation device 100 may access the left wall without obstruction by the robotic manipulator 210. Changing the orientation of the robotic manipulator 210 relative to the object manipulation device 100 may minimize or reduce the obstruction to robotic manipulation in accessing the walls of the trailer.

As shown in FIG. 8C, when the object manipulation device 100 reaches the object-gripping location, the distal edge (an edge toward the case) of the tool conveyor 110 may be in alignment with (e.g., parallel to) the bottom edge of the case 802 to be gripped. When the tool conveyor 110 is in alignment with the bottom edge of the case 802, the distal edge of the tool conveyor may contact or be adjacent to the bottom edge of the object. The control circuit 414 may use the positional and image information acquired from the sensor devices 430 and the image analyzing module 426 when it controls the robotic manipulator 210 to move and rotate the object manipulation device 100 and align the tool conveyor 110 with the case 802 to be gripped.

In step 704, the gripping tool 120 contacts, with the gripping surface of the gripping tool 120, one of the surfaces (e.g., side surface) of the case 802. In some embodiments, the gripping tool actuator 126 may extend the gripping surface beyond the distal edge of the tool conveyor 110 to grip the case 802. In some embodiments, the gripping tool actuator 126 may extend the gripping surface toward the case 802 while the robotic manipulator 210 moves the object manipulation device 100 toward the case. This simultaneous operation may reduce the cycle time of the manipulation of objects. The gripping tool actuator 126 may be controlled based on the positional and image information acquired from the sensor devices 430 and the image analyzing module 426.

In step 706, the gripping tool 120 grips the case. In some embodiments, the gripping tool 120 may grip the case by applying a vacuum suction force to the surface of the case 802. In some embodiments, the vacuum suction force may be applied with a suction cup array, a suction pad, or a combination thereof. In some embodiments, the gripping tool 120 may grip the case 802 with other types of forces/mechanism. For example, the gripping tool 120 may grip the case 802 using the plurality of fingers or the plurality of pins. In some embodiments, gripping the case 802 in step 706 may comprise applying a vacuum suction force on the surface of the case grasping, with a plurality of fingers, the case, and/or penetrating, with a plurality of pins, the surface of the case.

In step 708, the gripping tool 120 moves the gripped case 802 onto a conveyor surface of a tool conveyor as shown FIGS. 8C-8D. The gripping tool 120 may draw and put the case 802 onto the conveyor surface of the tool conveyor 110 by retracting, with the gripping tool actuator 126, the gripping surface 302, 304 of the gripping tool 120. While the gripping tool actuator 126 retracts the gripping surface to move the gripped case, at least a part of or an entire portion of the case 802 may be supported by tool conveyor 110. While the gripping tool 120 pulls the case 802 onto the conveyor surface of the tool conveyor 110, the conveyor speed and moving direction of the tool conveyor 110 may match the speed and moving direction of the gripping surface of the gripping tool 120.

In step 710, once the case 802 fully rests on the tool conveyor 110, the robotic manipulator 210 may rotate the object manipulation device 100 about an axis substantially perpendicular to the conveyor surface of the tool conveyor 110 as shown in FIGS. 8D-8F, which results in switching the proximal edge of the tool conveyor and the distal edge of the tool conveyor with each other again. The tool conveyor may be rotated in the opposite direction to the rotating direction in step 702. In some embodiments, While the robotic manipulator 210 rotates the object manipulation device 100, the gripping tool 120 may keep gripping the case 802, which may prevent the case from dropping from the tool conveyor 110 during the rotation. For example, the vacuum force of the suction cup array and/or the suction pad may keep being applied to the surface of the case 802. Similarly, the plurality of fingers and/or the plurality of pins may keep gripping the case 802 during the rotation. In other approaches, the gripping force (e.g., vacuum force of the suction cup) may not be applied to the surface of the case once the case 802 fully rests on the tool conveyor 110.

In step 712, the robotic manipulator 210 may move the object manipulation device 100 toward the object release location. Steps 710 and 712 may be conducted concurrently. The robotic manipulator 210 may move the object manipulation device 100 toward the object release location while rotating the object manipulation device. When the system 400 comprises the receiving conveyor 620, the robotic manipulator 210 may align the tool conveyor 110 with the receiving conveyor 620. Once the tool conveyor 110 is aligned with the receiving conveyor 620, the case 802 may be moved from the tool conveyor 110 to the receiving conveyor 620 as shown in FIGS, 8F-8G by either one or both of the tool conveyor 110 and the receiving conveyor 620.

In step 714, the system 400 may identify, with the sensor devices 430, a next case to be gripped. Although step 714 is illustrated after step 712, in some embodiments, the system may identify the next case to be gripped while one or more steps of steps 702 to 712 are being conducted. In some embodiments, the system 400 may identify the next object to be gripped prior to completion of object release from the object manipulation device 100 (i.e., tool conveyor 110).

The steps illustrated in FIG. 7 and FIGS. 8A-8G may be repeated to manipulate the next case. For example, the flow may continue after step 714, going back to step 702. Steps 702 to 714 may be repeated as many times as necessary. For example, steps 702 to 714 may be repeated until there remain no cases the system 400 should manipulate according to the method 700, or until the system 400 identifies no case to be gripped.

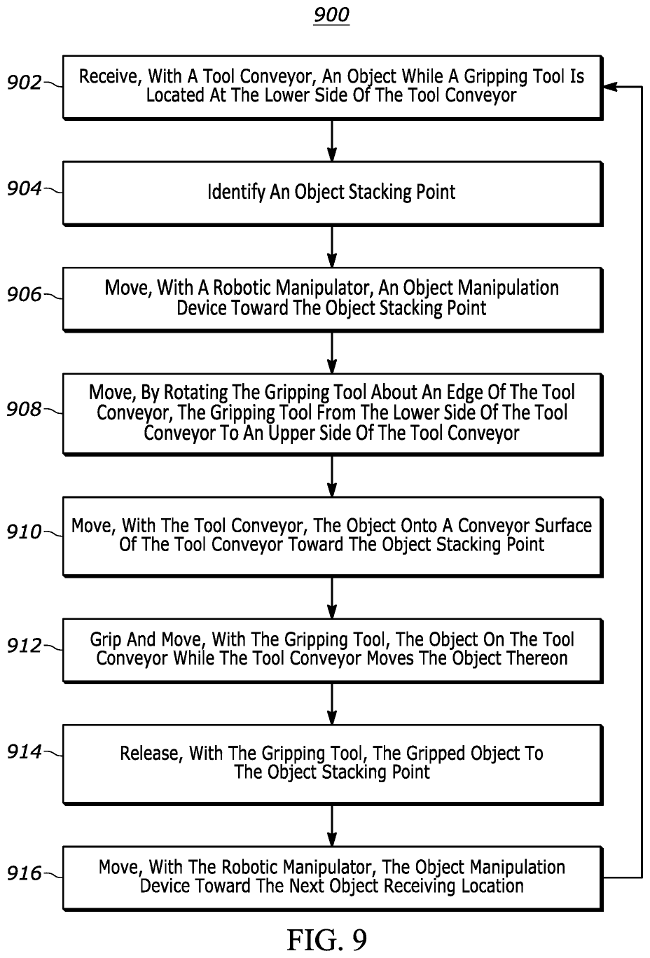

The system 400 including the object manipulation device 100 may be used in loading scenarios. In some embodiments, loading a trailer/container with the system 400 may generally be a reverse process of unloading process (e.g., method 500 in FIG. 5). FIG. 9 is a flowchart depicting an example method 900 to manipulate an object, especially in loading a trailer/container. In some embodiments, method 900 may be performed using the system 400 in accordance with the embodiments described above.

In step 902, the tool conveyor 110 may receive an object to be loaded while the gripping tool 120 is located at the lower side of the tool conveyor 110. In some embodiments, the object may be received via an edge of the tool conveyor 110. In some embodiments, the object may be received from another conveyor. For example, the receiving conveyor 620, which receives an object in an unloading scenario, may transfer an object to the tool conveyor 110.

In step 904, the system 400 identifies, with the sensor device 430, an object stacking point where the object to be stacked to load the trailer/container. Although step 904 is illustrated after step 902, the system 400 may identify the object stacking point before the completion of receiving the object in step 902. For example, the system may identify the object stacking point before or while step 902 is performed (but before completion of receiving). By identifying the object stacking point before the completion of receiving the object, the robotic manipulator 210 may start moving the object manipulation device 100 immediately after the completion of the receiving, such that the system 400 may avoid increases of the cycle time caused by image acquisition and process.

In step 906, once the entire portion of the object is released on the tool conveyor 110, the robotic manipulator 210 moves the object manipulation device 100 toward the object stacking point in the trailer/container.

In step 908, the gripping tool actuator 126 moves the gripping tool 120 from the lower side of the tool conveyor 110 to the upper side of the tool conveyor 110 by rotating the gripping tool 120 about the edge of the tool conveyor 110.

In step 910, the tool conveyor 110 moves the object on to the conveyor surface of the tool conveyor 110 toward the object stacking point by moving the object thereon toward the opposite edge of the tool conveyor 110.

In step 912, while the tool conveyor 110 moves the object thereon, the gripping tool 120 grips the object on the tool conveyor 110 and moves the object along with the conveyor movement of the tool conveyor 110. In some embodiments, any one or more of steps 908, 910, 912 may be performed while step 906 is performed.

In step 914, the object manipulation device 100 releases, with the gripping tool 120, the gripped object on the tool conveyor 110 to the object stacking point. In some embodiments, while the gripping tool 120 releases the object, the tool conveyor 110 may move the object when at least portion of object rests on the tool conveyor 110.

In step 916, after releasing the object to the object stacking point, the robotic manipulator 210 moves the object manipulation device 100 toward the next object receiving location to receive a next object. For example, when the next object is transferred from the receiving conveyor 620, the robotic manipulator 210 may move the object manipulation device 100 toward the receiving conveyor 620.

The steps illustrated in FIG. 9 may be repeated to manipulate the next case. For example, the flow may continue after step 916, going back to step 902. Steps 902 to 916 may be repeated as many times as necessary. For example, steps 902 to 916 may be repeated until there remain no cases the system 400 should manipulate according to the method 900.

In some embodiments, an object manipulation device comprises a base configured to be attached to a robotic manipulator, a tool conveyor coupled to the base, the tool conveyor having a conveyor surface configured to move an object on the conveyor surface from a first edge to a second edge of the tool conveyor, and a gripping tool having at least one gripping surface and coupled to the base via a gripping tool actuator, wherein the gripping tool actuator is configured to extend a gripping surface of the gripping tool to grip the object and retract the gripping surface to release the object onto the tool conveyor.

In some embodiments, an object manipulation method comprises moving, with a robotic manipulator, an object manipulation device toward an object to be gripped, the object manipulation device comprising a base configured to be attached to the robotic manipulator, a tool conveyor coupled to the base, and a gripping tool coupled, via a gripping tool actuator, to the base, contacting a first gripping surface of the gripping tool to a surface of the object to be gripped, gripping, with the gripping tool, the object; moving, with the gripping tool, the object onto a conveyor surface of the tool conveyor, and moving, with the tool conveyor, the object on the conveyor surface of the tool conveyor toward an object-release location.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1. An object manipulation device comprising:
a base configured to be attached to a robotic manipulator;
a tool conveyor coupled to the base, the tool conveyor having a conveyor surface configured to move an object on the conveyor surface from a first edge to a second edge of the tool conveyor; and
a gripping tool having at least one gripping surface and coupled to the base via a gripping tool actuator;
wherein the gripping tool actuator is configured to extend a gripping surface of the gripping tool to grip the object and retract the gripping surface to release the object onto the tool conveyor.

2. The device of claim 1, wherein the gripping tool actuator is configured to extend the gripping surface of the gripping tool beyond the first edge of the tool conveyor.

3. The device of claim 1, wherein the robotic manipulator is a multi-axis robotic arm.

4. The device of claim 1, wherein the gripping tool is movable from an upper side of the tool conveyor to a lower side of the tool conveyor and movable from the lower side of the tool conveyor to the upper side of the tool conveyor.

5. The device of claim 1, wherein the gripping tool comprises two gripping surfaces opposite each other.

6. The device of claim 1, wherein the tool conveyor is configured to rotate about an axis substantially perpendicular to the conveyor surface of the tool conveyor.

7. The device of claim 1, wherein the gripping tool actuator is configured to retract the gripping surface at a speed corresponding to a conveyor speed of the tool conveyor while the gripping tool is gripping the object and at least a portion of the gripped object is on the tool conveyor.

8. The device of claim 1, wherein the gripping tool actuator is configured to retract the gripping surface in a direction corresponding to a conveyor direction of the tool conveyor.

9. The device of claim 1, wherein conveyor speed of the tool conveyor is controllable based on a distance relative to an object-gripping location and an object-release location.

10. The device of claim 1, wherein the gripping tool comprises a suction cup, a suction pad, a plurality of fingers configured to grasp or pinch an object, a plurality of pins configured to penetrate surface of an object, or a combination thereof.

11. An object manipulation method, the method comprising:
moving, with a robotic manipulator, an object manipulation device toward an object to be gripped, the object manipulation device comprising a base configured to be attached to the robotic manipulator, a tool conveyor coupled to the base, and a gripping tool coupled, via a gripping tool actuator, to the base;
contacting a first gripping surface of the gripping tool to a surface of the object to be gripped;
gripping, with the gripping tool, the object;
moving, with the gripping tool, the object onto a conveyor surface of the tool conveyor; and
moving, with the tool conveyor, the object on the conveyor surface of the tool conveyor toward an object-release location.

12. The method of claim 11 further comprising moving, by rotating the gripping tool about an edge of the tool conveyor, the gripping tool from an upper side of the tool conveyor to a lower side of the tool conveyor.

13. The method of claim 12 further comprising moving, by rotating the gripping tool about the edge of the tool conveyor, the gripping tool from the lower side of the tool conveyor to the upper side of the tool conveyor.

14. The method of claim 11, wherein moving the object manipulation device toward the object to be gripped comprises aligning the conveyor surface of the tool conveyor with a bottom edge of the object to be gripped.

15. The method of claim 11 further comprising rotating, with the robotic manipulator, the tool conveyor about an axis substantially perpendicular to the conveyor surface of the tool conveyor.

16. The method of claim 15 further comprising contacting a second gripping surface of the gripping tool to a surface of a next object to be gripped.

17. The method of claim 11, wherein gripping, with the gripping tool, the object comprises applying a vacuum suction force on the surface of the object, grasping, with a plurality of fingers, the object, and/or penetrating, with a plurality of pins, the surface of the object.

18. The method of claim 11, wherein moving the object onto the conveyor surface of the tool conveyor comprises retracting, with the gripping tool actuator, the gripping tool at a speed corresponding to a conveyor speed of the tool conveyor.

19. The method of claim 11 further comprising controlling, based on a distance relative to an object-gripping location and the object-release location, a conveyor speed of the tool conveyor.

20. The method of claim 11 further comprising:
receiving, with the tool conveyor, an object while the gripping tool is located at a lower side of the tool conveyor;
moving, with the robotic manipulator, the object manipulation device toward an object stacking point;
moving the gripping tool from the lower side of the tool conveyor to an upper side of the tool conveyor; and
release, with the gripping tool, the object to the object stacking point.
